(19) United States
(12) Patent Application Publication
(10) Pub. No.: US 2006/0274813 A9
(43) Pub. Date: Dec. 7, 2006

(54) Nanoparticle thermometry and pressure sensors

(76) Inventors: Wei Chen, Stillwater, OK (US); Shaopeng Wang, Stillwater, OK (US); Sarah Westcott, Stillwater, OK (US)

Correspondence Address: DUNLAP, CODDING & ROGERS P.C., PO BOX 16370, OKLAHOMA CITY, OK, 73113, US

(21) Appl. No.: 10/460,531

(22) Filed: Jun. 12, 2003

Related U.S. Application Data
(63) Continuation-in-part of application No. 10/166,313, filed on Jun. 6, 2002, now Pat. No. 7,008,559.
(60) Provisional application No. 60/388,211, filed on Jun. 12, 2002.

(51) Int. Cl. G01K 11/00; G01K 13/00; G01K 1/14

(52) U.S. Cl. 374/161; 374/141

(57) ABSTRACT

A nanoparticle fluorescence (or upconversion) sensor comprises an electromagnetic source, a sample and a detector. The electromagnetic source emits an excitation. The sample is positioned within the excitation. At least a portion of the sample is associated with a sensory material. The sensory material receives at least a portion of the excitation emitted by the electromagnetic source. The sensory material has a plurality of luminescent nanoparticles luminescing upon receipt of the excitation with luminance emitted by the luminescent nanoparticles changing based on at least one of temperature and pressure. The detector receives at least a portion of the luminance emitted by the luminescent nanoparticles and outputs a luminance signal indicative of such luminance. The luminescence signal is correlated into a signal indicative of the atmosphere adjacent to the sensory material.

### CROSS REFERENCE TO RELATED APPLICATION

The present patent application claims priority to the provisional patent application identified by U.S. Ser. No. 60/388,211 filed Jun. 12, 2002.

### BACKGROUND OF INVENTION

Temperature is a fundamental property and its measurement is often required for both scientific research and industrial applications. For industrial manufacturing, real-time temperature monitoring can be used to optimize processing, minimizing waste and energy consumption. Spatially resolved temperature monitoring can establish regions of an integrated circuit in which heat builds up and suggest improvements in design of the circuit or its cooling system. Monitoring the temperature of high speed moving parts, such as turbine blades, can identify changes that signify a developing weakness in the blade. In bioengineering and biochemistry, temperature changes of even a few degrees can mean the difference between life and death for a cell.

Traditional methods of measuring temperature include thermocouples, thermistors, resistance temperature detectors (RTDs), and measurement of emitted infrared light. Thermistors, thermocouples, and RTDs all require electrical wiring, which is not suitable for applications in which electromagnetic noise is strong, sparks could be hazardous, the environment is corrosive, or parts are rapidly moving. In another approach, temperature can be determined from a measurement of the infrared light that is emitted from a hot sample. Infrared measurements have two essential flaws in sample comparison and common interferants. One can either assume that the sample emits at the same rate as a blackbody or for an accurate determination of temperature, the emissivity of the material must be known. For thermal imaging, the emissivity must be constant for all objects in the image. In addition, the infrared wavelengths typically used in determining temperature are absorbed by water vapor and by ordinary glass materials, preventing measurements through windows.

By using the fluorescence from luminescent materials to determine temperature, many of the problems and limitations of above methods can be avoided. Fluorescence from luminescent materials is known to depend on temperature in several ways. As the temperature of the phosphor is changed, the intensity of the fluorescence, the decay lifetime of the fluorescence, and the wavelength (or energy) of the fluorescence may all change. Because the fluorescence can be both excited and measured optically, fluorescence-based temperature sensors are advantageous compared to thermocouples in applications where electromagnetic noise is strong, electric wires might be hazardous, or it is physically difficult to connect a wire for instance in spinning centrifuges in turbines, or in wind tunnels.

Conventional phosphors are made from crystalline semiconductor materials and typically have grain sizes of several microns. These grains are mixed with a binder material and coated on the surface of a part whose temperature is to be measured. The grain size limits resolution by scattering both the excitation light and emitted light. It also imposes a minimum thickness of phosphor coating of several microns on the sample. Thick coatings are disadvantageous because the phosphor coating may act as an insulating layer on the part's surface, giving results for temperature that cannot be applied to similar uncoated parts. Also, the thermal mass is greater for thicker coatings. This introduces a delay in making temperature measurements while the sensor comes to thermal equilibrium with what it is measuring. Another approach to temperature sensing is to dope optical fibers, generally with rare earth ions, and observe the fluorescence of the dopants. There is a limited selection of materials for this approach.

Nanoparticles have enhanced emission efficiencies and faster decay times than bulk materials. In addition, their small size and the ultrathin films that can be made from nanoparticles enable high sensitivity, accuracy, and spatial resolution. Their small size means that they have a low thermal mass and can respond quickly to temperature changes. Their fast decay times are also required for a quick response to temperature changes.

Several temperature sensors using electrical measurements of nanoparticles have been developed. The Coulomb blockade thermometer (CBT) is based on the temperature dependence of electric conductance characteristics of tunnel junction arrays. The arrays are nanofabricated on nitridized or oxidized silicon substrate by electron beam lithography. The overall size of the sensor tip is in the sub-millimeter range. The application of this kind of thermometer is focused on cryogenic temperature monitoring, and the thermometer has been found insensitive to high magnetic fields. However, the temperature sensing only works at temperatures below 100 K.

Similar to temperature, pressure is also a fundamental property and its measurement is important for scientific research, medical, military and industrial applications. Conventionally, pressure is measured using manometers and through flow versus velocity measurements. Both are examples of pressure sensing on large scale items like reactors and pipes. Pressure is also measured based on the displacement of a diaphragm or using piezoelectric materials.

The pressure behaviors of phosphors are also similar to that of temperature, both related to the changes in crystal field or chemical bond-length. When temperature increases, the crystal field is weaker and the chemical bond is longer, whereas, when pressure increases, the crystal field is stronger and the chemical bond is shorter. Accordingly, the luminescence trends of temperature and pressure are different. Both temperature and pressure sensors can be designed and fabricated based on these dependencies.

Broadly, the present invention provides a method for using luminescence from nanoparticles to measure temperature or pressure; a method for using fluorescent resonant energy transfer from nanoparticles to measure temperature or pressure; and a method for using upconversion luminescence from nanoparticles to measure temperature or pressure.

### SUMMARY OF THE INVENTION

Temperature and pressure can be determined by measuring fluorescent properties such as the intensity, the decay lifetime, or the wavelength. Using nanoparticles, particles with dimensions of less than 1000 nm, as the fluorescent material offers advantages for fluorescence-based thermometry such as higher resolution, incorporation into a variety of media, thinner coating layers, lower cost, and higher sensitivity. The energy transfer rate from a donor to an acceptor is temperature and/or pressure dependent. As a result, the luminescence from a donor-acceptor pair is sensitive to temperature and/or pressure changes. This allows one to design and fabricate an energy transfer system for temperature and/or pressure sensors, including a system composed of two sizes or two kinds of nanoparticles; or one nanoparticle or one host with two emitters. Thermometry or temperature imaging is also possible using the temperature-dependent upconversion luminescence of nanoparticles. An upconversion temperature sensor or upconversion imaging might have higher resolution and/or sensitivity because the luminescence background is much lower than in fluorescence.

Using nanoparticles for temperature sensors or nanothermometry or nanothermometers may overcome the limitations of conventional phosphors as mentioned above. Luminescent nanoparticles with high quantum efficiency make it possible to design and fabricate more sensitive temperature sensors. It is known that oscillator strength is a very important optical parameter that determines the absorption cross-section, recombination rate, luminescence efficiency, and the radiative lifetime in materials. The oscillator strength of the free exciton is given by the formula:

$${f}_{e x} = \frac{2 m}{η} Δ E {\vert μ \vert}^{2} {\vert U ( 0 ) \vert}^{2}$$

where m is the electron mass, ΔE is the transition energy, μ is the transition dipole moment, and |U(0)|² represents the probability of finding the electron and hole at the same site (the overlap factor). In nanostructured materials, the electron-hole overlap factor increases largely due to the quantum size confinement, thus yielding an increase in the oscillator strength. The oscillator strength is also related to the electron-hole exchange interaction that plays a key role in determining the exciton recombination rate. In bulk semiconductors, due to the extreme dislocation of the electron or hole, the electron-hole exchange interaction term is very small; while in molecular-size nanoparticles, due to the confinement, the exchange term should be very large. Therefore, one may expect a large enhancement of the oscillator strength from bulk to nanostructured materials.

In doped semiconductors, excitons are bound to impurity centers. The oscillator strength is given by the formula:

$${f = {f}_{e x} \vert \int ⅆ x F ( x ) \vert}^{2} / {Ω}_{m o l} ,$$

where fₑₓ is the oscillator strength of the free exciton and Ωₘₒₗ is the volume of one molecule. The oscillator strength of a bound exciton is actually given by fₑₓ multiplied by the number of molecules covered by the overlap of the electron and hole wave functions. Clearly, quantum size confinement will also enhance the bound exciton oscillator strength in doped nanoparticles. The luminescence efficiency is also proportional to the exciton oscillator strength; therefore, it can be enhanced via quantum size confinement. Strong evidences for the above theory are from our observations on ZnS:Mn²⁺ nanoparticles as reported in W. Chen, R. Sammynaiken, Y. Huang, J. Appl. Phys. Luminescence Enhancement of ZnS:Mn Nanoclusters in Zeolite, 2000, 88, 5188 (2000) and EuS, W. Chen, X. H. Zhang, Y. Huang, Luminescence Enhancement of EuS Clusters in USY-Zeolite, Appl. Phys. Lett., 76 (17): 2328-2330 (2000). The luminescence intensity of the 1 nm sized ZnS:Mn²⁺ nanoparticles in zeolite-Y was reported to be much stronger than other nanoparticles in W. Chen, R. Sammynaiken, Y Huang, J. Appl. Phys. Luminescence Enhancement of ZnS:Mn Nanoclusters in Zeolite, 2000, 88, 5188 (2000). More interesting is that bulk EuS at room temperature is reported as not luminescent but strong luminescence was observed when EuS nanoparticles were formed in zeolite (see W. Chen, X. H. Zhang, Y Huang, Luminescence Enhancement of EuS Clusters in USY-Zeolite, Appl. Phys. Lett., 76 (17): 2328-2330 (2000)).

The radiative decay lifetime (τ) which is closely related to the oscillator strength of a transition, is represented by the formula:
τ=4.5(λ_{A}²/nf),
where n is the refractive index and λ_{A} is the wavelength. Thus, the lifetime is shortened with decreasing size due to the increase of the oscillator strength, f. High efficiency with short decay times makes nanoparticles good candidates for luminescence based temperature sensors.

It is generally accepted that the major non-radiative energy relaxation channel in semiconductors is due to thermal quenching, also known as phonon quenching. The density of phonons increases with temperature, increasing the non-radiative relaxation rate and therefore in effect decreasing the amount of fluorescent light. If the phonon coupling is stronger, the non-radiative rate is higher and the luminescence is more sensitive to temperature change. Based on the theory of phonon quenching, the temperature dependence of the emission intensity, I(T), can be determined by the formula:

$$I ( T ) = \frac{{I}_{0}}{1 + a {ⅇ}^{- {E}_{b} / K T}} \qquad ( 1 )$$

where E_{b} is the activation energy (thermal quenching energy), K is the Boltzmann constant, α is a constant related to the ratio of the non-radiative rate to the radiative rate, and I₀ is the emission intensity at 0 K. Excellent agreement between theory and experiment in most cases suggests that the intensity decrease of a nanoparticle (or phosphor) with a single emitting center is due to thermal quenching. Note that this thermal quenching is a reversible process.

With some nanoparticles, an enhancement in intensity or an irreversible change will be seen with an increase in temperature. Irreversible quenching is generally related to a chemical dissociation or oxidation. Irreversible enhancements are generally related to thermal curing or passivation of the nanoparticle surface, generally resulting in an enhancement. Another possible cause of enhancement is thermoluminescence. Upon heating, carriers at some traps are released to the conduction band and contribute to the luminescence. As a result, the luminescence increases with increasing temperature. As the trapped sites are thermally emptied, the luminescence enhancement decreases in intensity.

Shifts in emission energy, or equivalently wavelength, with temperature can be described by crystal field theory. The crystal field strength is enhanced at lower temperatures because the crystal lattice has physically contracted. As a consequence, the emitting state shifts to lower energies with decreasing temperature, shifting the emission to longer wavelengths.

Variation of hydrostatic pressure can change the inter-atomic distance and the overlap among adjacent electronic orbitals. Pressure dependence of luminescence can provide useful information about the electronic state of an emitter and the interaction between the luminescence centers and their hosts. On the other hand, pressure can be measured though the measurement of luminescence changes. Nanoparticles, due to their size determined quantum confinement, present different pressure dependent luminescence properties than bulk materials and have great potential to be used for pressure sensing applications.

In addition to single or single sized nanoparticles the present invention relates to a system composed of two or more nanoparticles of different sizes or with two or more different kinds of nanoparticles or one nanoparticle with two emitting centers. In these complex systems, there will be energy transfer from one nanoparticle (donor) to the other (acceptor) or from one emitter (donor) to the other (acceptor), by a process known as fluorescence resonance energy transfer (FRET). This energy transfer rate is inversely dependent on the 6^{th} power of the distance between the donor and the acceptor. Thus, if the distance is changed slightly by varying temperature or pressure, the energy transfer rate will be changed greatly. As a result, the luminescence intensity and lifetime are related to temperature and pressure. Based on this theory, temperature or pressure sensors may be made with these systems.

In addition to fluorescence, upconversion luminescence may have some advantages for temperature or pressure sensors as described in this invention. Upconversion luminescence is different from photoluminescence or fluorescence. In upconversion luminescence the excitation wavelength (energy) is longer (lower) than the emission wavelength (energy). This is opposite to what occurs in fluorescence or photoluminescence. Upconversion luminescence has many applications like energy upconversion, infrared imaging, biological labeling and displays. Strong upconversion luminescence has been observed in some nanoparticles. For example, two-photon-induced upconversion luminescence was first observed in ZnS:Mn²⁺ and ZnS:Mn²⁺,Eu³⁺ nanoparticles by one of the present inventors and such observations are reported in W. Chen, A. G Joly, and J. Z. Zhang, Up-Conversion Luminescence of Mn²⁺ in ZnS:Mn Nanoparticles, Phys. Rev. B, 2001, 64, 0412021-4(R) and A. G. Joly, W. Chen, J. Roark, and J. Z. Zhang, Temperature dependence of Up-Conversion Luminescence of Mn²⁺ in ZnS:Mn Nanoparticles, Journal of Nanoscience and Nanotechnology, 2001, 1 (3): 295-301. The observation revealed that the upconversion luminescence intensity of ZnS:Mn²⁺ nanoparticles is highly temperature dependent. One of the present inventors also observed a close-to-linear temperature dependence of the upconversion intensity in ZnS:Mn²⁺ nanoparticles formed in zeolite-Y. This observation is reported in A. G. Joly, W. Chen, J. Roark, and J. Z. Zhang, Temperature dependence of Up-Conversion Luminescence of Mn²⁺ in ZnS:Mn Nanoparticles, Journal of Nanoscience and Nanotechnology, 2001, 1 (3): 295-301. This indicates that the upconversion luminescence of nanoparticles can be used in temperature sensors. One advantage of upconversion in temperature sensing or imaging is that the resolution or accuracy is better compared with fluorescence, because the emission background from the surroundings can be avoided in upconversion. This is particularly desirable in biological or biomedical applications, such as temperature monitoring during hyperthermia treatment of cancer.

In addition, for upconversion luminescence other than two-photon absorption, an energy transfer process from donor to acceptor is very important. For electric multipolar interactions the energy transfer probability can be determined by the formula:

$${P}_{S A} ( R ) = \frac{{( {R}_{0} / R )}^{S}}{{τ}_{S}}$$

where τ_{S} is the actual lifetime of the donor excited state, R₀ is the critical transfer distance for which excitation transfer and spontaneous deactivation of the donor have equal probability, and R is the separation between the donor and the acceptor. s is a positive integer taking the following values:
s=6 for dipole-dipole interactions
s=8 for dipole-quadrupole interactions
s=6 for quadrupole-quadrupole interactions
   The above theory indicates that donor-acceptor separation is a key parameter determining the energy transfer rate. From the above equation, it is known that the energy transfer rate is highly dependent on the separation between the donor and the acceptor. Different temperatures or pressures have different separations, and, of course, different transfer rates. As a result, upconversion luminescence efficiency and lifetime are different with different temperature and pressure. This is the basic concept behind upconversion temperature or pressure sensors.

Thermometry based on upconversion luminescence has been reported in bulk Er³⁺- and Er³⁺—Yb³⁺-doped chalcogenide glasses. In nanoparticles, due to small size and large surface/volume ratio, the separation between donor and acceptor ions may be “squeezed” and become shorter. Thus, energy transfer rate and upconversion efficiency are enhanced. This is one of the advantages of using nanoparticles as temperature sensors as compared to conventional phosphors.

Compared to conventional phosphor materials:
1. Nanoparticles allow higher spatial resolution due to their smaller size.
2. Nanoparticles result in less light scattering due to their smaller size. This provides more emitted light for the same power or the same emitted light levels for less power. It also contributes to the higher spatial resolution.
3. Nanoparticles have enhanced quantum efficiency for emission due to their small size leading to better overlap of electron and hole levels. Again, this provides more emitted light for the same power or the same emitted light levels for less power.
4. Nanoparticles have a faster emission decay time due to their small size leading to better overlap of electron and hole levels. This permits faster measurements of temperature or pressure, which could be particularly important for fast-moving parts, such as turbine blades.
5. Coatings containing nanoparticles are thinner, reducing the insulating effect of the coating.
6. Coatings containing nanoparticles are thinner, leading to faster equilibration times between a hot part and the nanoparticle coating.
7. It is possible to directly bond linking molecules to nanoparticles and use those molecules to bind to surfaces. Conventional phosphor grains are too large to be bound in this way; that is why the grains must be mixed with a macroscopic binder material before coating. If molecules are used for binding rather than a polymer or epoxy binder, the coating layer will be even thinner (see 5 and 6) and the nanoparticles will be present at a higher concentration, increasing the signal.
8. Nanoparticles are small enough to inject into biological cells.
9. The linking molecules mentioned in point 7 can be biologically-based, such as antibodies, allowing nanoparticles to be bound to a biological sample of interest.

Compared to temperature sensing based on measuring the infrared (IR) wavelength emissions from a sample:
1. To quantitatively determine the temperature using IR sensitivity, the emissivity of the sample must be known. Emissivity can vary quite widely depending on the material and how smooth its surface is. If a thermal image (or a determination of temperature at multiple points such as a two-dimensional image) is to be taken, then all objects in the image must have the same emissivity or the image will be misleading. An object with higher emissivity will appear to be at a higher temperature than an object with lower emissivity, even if their temperature is the same.
2. The IR wavelengths used for this sensing can be absorbed by ordinary glass, plastics and water vapor. Fluorescence (or upconversion) wavelengths that are not absorbed by these materials can be used.

Compared to thermocouples, resistance temperature detectors, and thermistors:
1. As an optical method, fluorescence (or upconversion) sensing can be conducted as a non-contact measurement, which is practical for moving parts.
2. As an optical method, fluorescence (or upconversion) sensing is not sensitive to electromagnetic noise.
3. As an optical method, fluorescence (or upconversion) sensing does not require electrical wires with current running through them, so there is no risk of sparks in hazardous environments.
4. As an optical method, fluorescence (or upconversion) sensing can use optical fibers to transmit the excitation light and emitted light. Optical fibers are less susceptible and can be more easily protected in corrosive environments than electrical wiring.

Compared to molecular fluorophores
1. Nanoparticles are less susceptible to photobleaching and more stable.

Comparing upconversion luminescence to fluorescence
1. If upconversion luminescence, rather than fluorescence is used, the infrared excitation wavelengths required for upconversion luminescence will not lead to background fluorescence of the sample.

### BRIEF DESCRIPTION OF THE DRAWINGS

FIG. 1 is a schematic representation of an excitation and detection system for nanoparticle thermometry or pressure sensing in accordance with the present invention.

FIG. 2 is a schematic representation of nanoparticle labeled antibody/receptor for target specific temperature sensing.

FIG. 3 is a schematic representation of layer-by-layer assembled nanoparticle thin film for temperature sensing based on FRET.

FIG. 4A is the emission spectra of Zn₂SiO₄:Mn²⁺, Eu³⁺ at different temperatures.

FIG. 4B is the change in emission intensity of 610 nm (Eu3+) and 525 nm (Mn2+) in Zn₂SiO₄:Mn²⁺, Eu³⁺ at different temperatures.

FIG. 5 is a schematic representation of in-vivo temperature monitoring using temperature sensitive nanoparticle labeling.

FIG. 6A is a graphical representation of the fluorescence spectra of CdTe nanoparticles at different temperatures, from top to bottom: 30° C. to 60° C., excitation wavelength: 350 nm.

FIG. 6B is a graphical representation of the fluorescence peak intensity (518 nm) of CdTe nanoparticles as a function of temperature.

FIG. 7A is a graphical representation of the fluorescence spectra of ZnS:Mn²⁺ nanoparticles at different temperatures, from top to bottom: 30° C. to 150° C., excitation wavelength: 360 nm.

FIG. 7B is a graphical representation of the fluorescence peak intensity at 589 nm of ZnS:Mn²⁺ nanoparticles as a function of temperature.

FIG. 8A is a graphical representation of the emission spectra of defect-related blue (DA) and Mn²⁺ emissions in ZnS:Mn²⁺ nanoparticles.

FIG. 8B is a graphical representation of the temperature dependence of emission spectra, emission intensity, wavelength and bandwidth of the defect-related blue (DA) and Mn²⁺ emissions in ZnS:Mn²⁺ nanoparticles.

FIG. 9A is a graphical representation of a fluorescence spectra of BaFBr:Eu³⁺ nanoparticles in MCM 41 at different temperatures, from top to bottom: 30° C. to 150° C., during a heat up and cool down cycle, excitation wavelength: 280 nm.

FIG. 9B is a graphical representation of a fluorescence peak intensity (388 nm) of BaFBr:Eu ³⁺ nanoparticles as a function of temperature. Squares: heating up, circles: cooling down.

FIG. 10A is a graphical representation of fluorescence spectra of Eu³⁺ nanoparticles in zeolite at different temperatures, from top to bottom: 30° C. to 140° C., excitation wavelength: 392 nm.

FIG. 10B is a graphical representation of fluorescence peak intensity (611 and 588 nm) of Eu³⁺ nanoparticles as a function of temperature.

FIG. 10C is a graphical representation of ratio of the two fluorescence peaks (611 nm/588 nm) as function of temperature.

FIG. 11A is a graphical representation of the fluorescence spectra of ZnS:Mn²⁺:Eu³⁺ nanoparticles at different temperatures, 30° C. to 150° C., of the excitation wavelength: 394 nm, peak of Eu³⁺.

FIG. 11B is a graphical representation of the fluorescence spectra of ZnS:Mn²⁺:Eu³⁺ nanoparticles at different temperatures, 30° C. to 150° C., of the excitation wavelength: 360 nm, peak of Mn²⁺.

FIG. 11C is a graphical representation of the fluorescence spectra of ZnS:Mn²⁺:Eu³⁺ nanoparticles at different temperatures, 30° C. to 150° C., of the fluorescence peak intensity as a function of temperature. Square: 612 nm (ex: 394 nm), round: 595 nm (ex: 360 nm).

FIG. 11D is a graphical representation of the fluorescence spectra of ZnS:Mn²⁺:Eu³⁺ nanoparticles at different temperatures, 30° C. to 150° C., of the intensity ratio of the two peaks (595 nm/612 nm) as a function of temperature.

FIG. 12 is a graphical representation of the photoluminescence spectra of the aPPE-ZnS:Mn²⁺ nanocomposite following excitation at different wavelengths. The inset displays the variation in luminescence intensity of the different emissions as a function of excitation wavelength.

FIG. 13 is a graphical representation of the luminescence spectra of the aPPE-ZnS:Mn²⁺ nanocomposite at different temperatures ranging from 11 to 276 K.

FIG. 14 is a graphical representation of the emission energy maxima of the defect (diamonds), Mn²⁺ (squares), 490 nm aPPE (stars), and 460 nm aPPE (triangles) emissions at different temperatures below room temperature.

FIG. 15 is a graphical representation of the emission intensity of the defect (diamonds), Mn²⁺ (squares), 490 nm aPPE (stars), and 460 nm aPPE (triangles) emissions at different temperatures below room temperature. The error is within 2%.

FIG. 16 is a graphical representation of the intensity temperature dependence of the aPPE emission at 460 nm and the Mn²⁺ emission from room temperature to 60° C. The 460 nm emission decreases in intensity upon heating (▪), however the intensity does not recover upon subsequent cooling (●). The Mn²⁺ emission increases upon heating (▴) but only partially recovers upon subsequent cooling (▾). The error is within 2%.

FIG. 17 is a graphical representation of the intensity temperature dependence of the aPPE emission at 460 nm and the Mn²⁺ emission from room temperature to 140° C. following one cycle of heating and cooling described in FIG. 13. Above 60° C. the emission of aPPE upon heating (♦) decreases steadily and is completely quenched at 140° C. The luminescence intensity does not recover following subsequent cooling (X). The Mn²⁺ emission intensity also decreases from 60° C. to 140° C. (+) upon heating, and it is completely quenched at 140° C. The intensity also does not recover upon cooling (*). The error is within 2%.

FIG. 18A is a graphical representation of the photoluminescence spectra of In2S3:Eu nanoparticles at different temperature, excitation wavelength 370 nm.

FIG. 18B is a graphical representation of the fluorescence intensity ratio of 435 nm and 614 nm peak at different temperatures.

FIG. 19A is a graphical representation of the PL spectra for ZnS:Mn²⁺ nanoparticle and bulk samples under various pressures.

FIG. 19B is a graphical representation of the PL spectra for ZnS:Mn²⁺ nanoparticle and bulk samples under various pressures.

FIG. 20 is a graphical representation of the pressure dependence of the integrated intensity of the orange emission for 1 nm, 3 nm, 3.5 nm, 4.5 nm and 10 nm-sized ZnS:Mn²⁺ nanoparticles. The solid lines serve only to guide the eye.

FIG. 21 is a graphical representation of the pressure dependence of the orange emission in ZnS:Mn²⁺ nanoparticles and corresponding bulk. The solid lines are the least-squares fit to the data.

FIG. 22 is a graphical representation of the pressure dependence of the emission bandwidth of Mn²⁺ in the 1 nm, 3 mm, 3.5 nm, 4.5 nm and 10 nm-sized ZnS:Mn²⁺ nanoparticles. The solid lines serve only to guide the eye.

FIG. 23 is a schematic representation of a process for calibrating the sensor system to compensate for at least one environmental condition.

### DETAILED DESCRIPTION OF THE PREFERRED EMBODIMENT

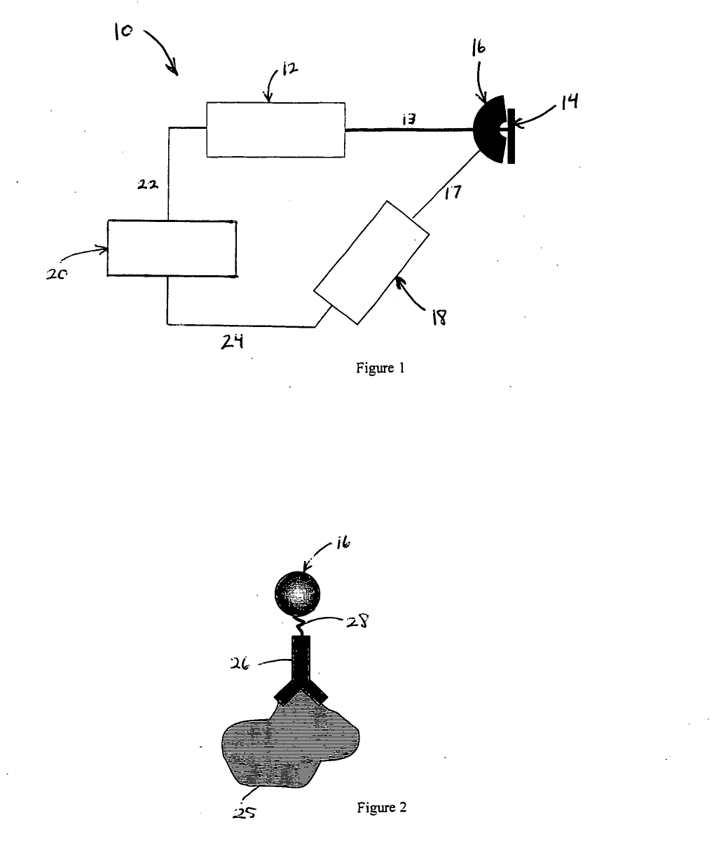

Referring now to FIG. 1, shown therein is a nanoparticle fluorescence (or upconversion) sensor system 10 constructed in accordance with the present invention. It should be noted that, in the description of preferred embodiments, like numerals will be used for like components in the description of the various figures of the drawings. The sensor 10 is provided with a light source 12, a sample 14 coated with a sensor material 16, a light detector 18 and a processor 20. The light source 12 emits light 13 generally in the direction of the sample 14. The light 13 emitted by the light source 12 is typically of a constant or known energy level. Preferably a laser is used as the light source 12. In general, the light source 12 shines light onto the sample 14 that has been coated with the sensory material 16. In a preferred embodiment, the sensory material 16 is nanoparticles which emit light 17 either through fluorescence or upconversion luminescence. Although the light 17 is emitted in many directions, some of the emitted light 17 will travel in the correct direction to reach the detector 18. The detector 18 measures the intensity, wavelength shift, lifetime, or intensity ratio depending on which property is being used for temperature (or pressure) detection in a given case. If the change in excitation spectrum is to be measured, the light source 12 must be tunable to excite at different wavelengths. As shown in FIG. 1, the light source 12 is connected to communicate with the processor 20 via a signal path 22 and the detector 18 is connected to communicate with the processor 20 via a signal path 24.

In most applications, optical elements, such as lenses, would be used to focus the laser light and collect the emitted light and filters would be used to block the excitation light from reaching the detector. The laser 12 could be replaced by a high power lamp or light emitting diode for some applications and the excitation source could be pulsed or continuous. Arrangements for scanning the excitation light across the sample could be made. The detector 18 could be a two-dimensional imaging detector, such as a digital camera or CCD array, rather than measuring intensity only at a single point. Optical fiber, or another optical waveguide, could run between the laser and the sample 14 or the sample 14 and the detector 18. When employing optical fibers or another wave guide, appropriate optical elements would be required for coupling into and out of the fiber.

In the following examples, several embodiments of the present invention will first be explained and thereafter the fluorescence properties of a number of nanoparticles as a function of temperature and pressure will be shown. The nanoparticles tested may be categorized into four classes: semiconductor nanoparticles (CdTe, CdSe, ZnO, CdS, ZnS, In₂S₃), Mn²⁺-doped semiconductor nanoparticles (CdS:Mn²⁺, ZnS:Mn , ZnS:Mn²⁺, Eu³⁺, etc), europium (Eu³⁺ or Eu²⁺)-doped nanoparticles (Y₂O₃:Eu³⁺, ZnS:Eu³⁺, Zeolite-Eu³⁺, MgS:Eu³⁺, BaFBr:Eu³⁺, BaFBr:Eu²⁺, In₂S₃:Eu³⁺, etc) and polymer/semiconductor hybrid nanoparticles (aPPE/ZnS:Mn²⁺). While specific nanoparticles and dopants have been disclosed, it is to be understood that other nanoparticles may be suitable for thermometry in accordance with the present invention.

### EXAMPLE 1

An application of nanothermometry is localized in vivo temperature probing. In the current art, polymer beads (80-90 nm in diameter) containing fluorescent molecules have been used to measure the temperature of a single living cell for disease and cancer diagnosis. However, these fluorescent molecules are susceptible to photobleaching and are not suitable for long-term monitoring. Nanoparticles are less susceptible to photobleaching, are even smaller for injection into the cell, and can be readily conjugated to biomolecules, such as antibodies, to control where they will bind (see FIG. 2). This site-specific. conjugation approach will yield nanoparticle-antibody conjugates having high binding affinity to the target.

### EXAMPLE 2

Nanoparticle thermometry can also be used to monitor local temperature of macro molecules in vitro; one example is the hybridization and dehybridization of DNA during the polymer chain reaction (PCR) for amplification of genes, where temperature plays a key role. In the current art, an organic phosphor such as 6-carboxyfluorescein has been chemically attached to the end of DNA molecules to monitor the temperature of the DNA molecule locally, by measuring the fluorescence emission intensity. The nanoparticles disclosed herein may be used as a replacement for the organic phosphors with similar benefits as described in Example 1.

### EXAMPLE 3

To utilize the FRET response between different nanoparticles for the thermometry application, a proper linking method needs to be selected to make the two kinds of nanoparticles close enough for FRET. The linker needs to have thermal expansion properties that will vary the FRET distance thermally. Either chemical or physical linking methods could be selected. A properly selected organic linker molecule with functional groups that can conjugate to the stabilizer on the surface of each kind of nanoparticles is one approach. The advantages of such molecular linking are strong and stable linking. A physical linking method, layer-by-layer assembly, should provide a general approach for making a FRET nanostructure.

G. Decher initially introduced layer-by-layer (LBL) assembly for oppositely charged polyelectrolytes as discussed in G. Decher, Fuzzy Nanoassemblies: toward Layered Polymeric Multicomposites, Science 277, 1232-1237 (1997), the entire content of such reference is hereby expressly incorporated herein by reference. It was later expanded to the assembly of various inorganic colloids. One of the most promising directions of this technique is that the preparation of hybrid organic-inorganic materials affords the combination of optical and electric properties of inorganic components with excellent adhesion, processability and flexibility of polymers. Kotov et al. were the first to report LBL assembly of II-VI semiconductor nanoparticles, where the light emitting properties of quantum dots were successfully integrated into a thin hybrid film, as discussed in N. A. Kotov, I. Dekany, and J. H. Fendler, Layer-by-layer self-assembly of polyelectrolyte-semiconductor nanoparticle composite films, J. Phys. Chem. 99, 13065-13069 (1995), the entire content of such reference is hereby expressly incorporated herein by reference. The driving force for LBL is the electrostatic attraction of positive and negative charges located on the surface of inorganic colloids and polyelectrolytes. An important thermodynamic contribution to the film stability is also made by the van der Waals interactions. The distance between the different types of nanoparticles can be controlled by the type, number of layers and deposition conditions of the polyelectrolytes, as discussed in N. Malikova, I. Pastoriza-Santos, M. Schierhorn, N. A. Kotov, and L. M. Liz-Marzän, Layer-by-Layer Assembled Mixed Spherical and Planar Gold Nanoparticles: Control of Interparticle Interactions, Langmuir 18, 3694-3697 (2002), the entire content of such reference is hereby expressly incorporated herein by reference. The packing density of the polyelectrolyte media between nanoparticle layers will be selected to have a large thermal expansion coefficient; therefore, the distance between the different sized nanoparticles will change with temperature.

Polyethylene has a large thermal expansion coefficient, about 1.3×10-4 K⁻¹ at room temperature, which makes it a good candidate for the media between the nanoparticle layers. It will give an estimated temperature sensing resolution of less than 1° C. according to calculations based on the relationship of FRET transfer and distance as well as the detection limit of the fluorometer.

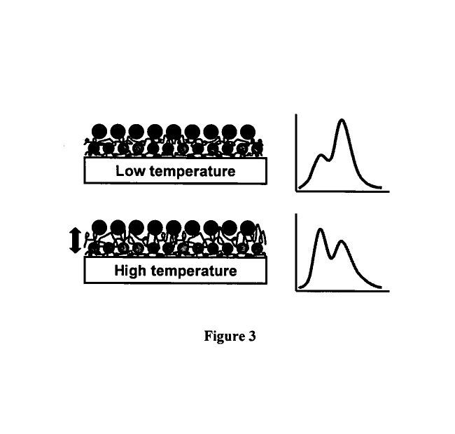

The fluorescence spectra of the constructed thin film should vary at different temperatures as the relative fluorescence peak intensity of the two different sized CdTe nanoparticles changes. As shown in FIG. 3, it is expected that at low temperature, the distance between the two sizes of nanoparticles is small; therefore the FRET rate is high. The peak of the red emitting nanoparticles is high and that of the green emitting nanoparticles is low. As the temperature increases, the polyethylene layer expands; therefore the distance between the two kinds of nanoparticles increases. The FRET rate decreases, resulting in decreased intensity of the red emission peak and increased intensity of the green emission peak.

Although specific polymers and nanoparticles have been mentioned here, this approach should also apply to other nanoparticles and other spacer layers (such as polymers, polyelectrolytes, or non-fluorescent nanoparticles). Additionally, layer-by-layer deposition is not the only technique that could be used to make the spacer layer. For example, it might be possible to attach monomers to the bound “green emitter” nanoparticles, followed by attachment of the “red emitters” to the bound monomers, and then polymerize. Sputter coating might also serve for the spacer layer.

### EXAMPLE 4

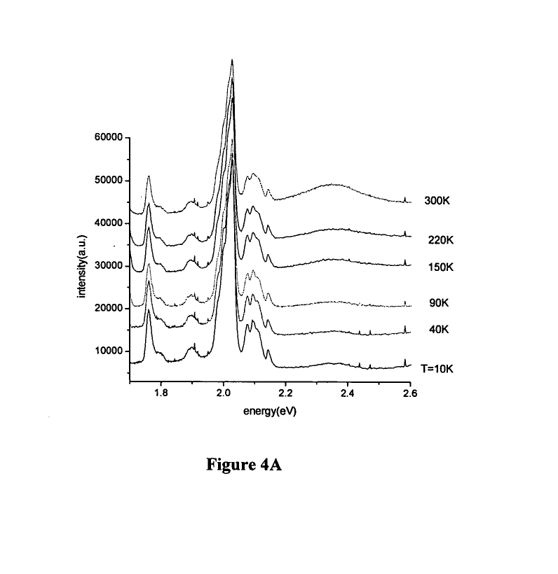

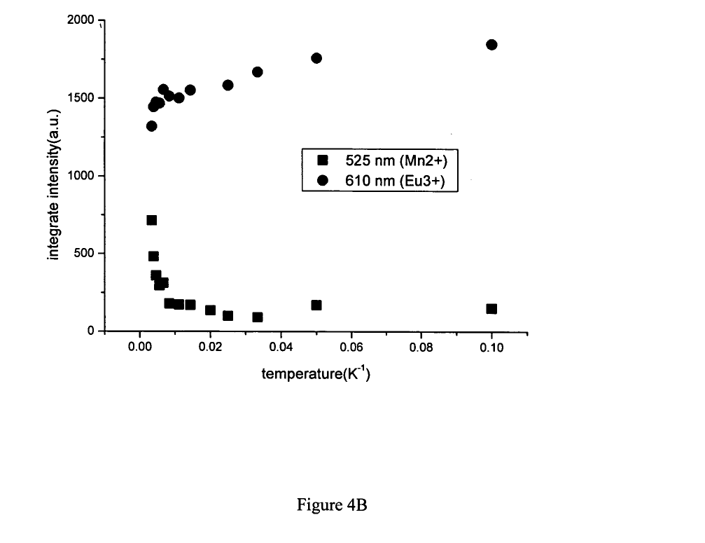

Here we give another example for FRET temperature or pressure sensors. In this example, two emitters Mn2+ and Eu3+ are doped into Zn2SiO4 and energy can transfer from Mn2+ to Eu3+due to energy resonance of the two emitters. The strongest emission peak of Eu3+ is at 610 nm (2.03 eV) and that of Mn2+ is at 525 nm (2.36 eV). FIGS. 4A and 4B show the temperature dependence of the emission spectra and the intensity change of the 610 nm (Eu3+) and 520 nm (Mn2+) from Zn2SiO4:Mn2+, Eu3+. It shows clearly that the intensity of Eu3+decreases while that of Mn2+ increases upon increasing temperature. This is because the energy transfer rate is decreased as temperature is increased. This is a good example for using FRET for temperature measurement.

### EXAMPLE 5

The North American Hyperthermia Society defines hyperthermia as the application of heat in a therapeutic setting. In this medical treatment, the patient (either whole body or in a specific region) is heated to an elevated temperature. Heating cancerous tumors to temperatures in the range of 41-45° C. can sensitive the cancer cells, making other treatments, such as radiation or chemotherapy, more effective. Heating to higher temperatures can directly kill the cells. In both applications, monitoring the temperature of the cells would confirm that the cells had been heated sufficiently. Because nanoparticles can be conjugated to biological molecules that are selective towards cancer cells, nanoparticles could be injected that would travel to a tumor, bind, and then allow temperature monitoring during hyperthermia treatment. If the excitation and emission light are to travel through skin and tissue, the wavelengths at which these processes occur must be carefully chosen to correspond to the maximum transparency of the human body.

Hyperthermia treatment can also be delivered to deeper locations in the body using catheters. Referring to FIG. 5, optical fibers 30A and 30B are connected to the laser 12 and the detector 18, respectively. The optical fiber 30A and 30B are run through a catheter 32. Nanoparticles 16 bound to (or near) such a deep tumor 34 could be interrogated for temperature sensing, as illustrated in FIG. 5.

### EXAMPLE 6

Because of its transparency, the eye may be especially suited for temperature and/or pressure monitoring using nanoparticles' fluorescence or upconversion luminescence. This could be done during diagnostic procedures, as for glaucoma, or during treatment, such as radial keratomy, photorefractive keratectomy, and laser in-situ keratomileusis.

### EXAMPLE 7

Ultrasonic testing can be an important non-destructive evaluation technique. However, traditional ultrasound measurements are point or line measurements. A transducer is placed on the part to be tested, an ultrasonic pulse is applied, and the transmission or reflection of that pulse is measured. However, point (or line) measurements are relatively time consuming. A technique that could determine pressure over a large area of the sample simultaneously is desirable.

Pressure-sensitive nanoparticles should provide a convenient imaging detection method for acoustography, in which the ultrasonic waves moving through the sample are directly converted into an optical image in real-time. The nanoparticles could be easily applied directly on curved parts or could be applied to a flexible film (such as a polymer) to make a portable, flexible detector. During measurements, the fluorescence (or upconversion) of the nanoparticles would change as the ultrasonic pulses traveled through the sample, changing the pressure at the surface.

A FRET-based system, similar to that described in Example 3, would also be suitable for acoustography measurements.

### EXAMPLE 8

An advantage of non-contact measurements is that they can be used with moving parts. Techniques have been developed to synchronize a temperature measurement (using conventional phosphors) with the rotational speed of a turbine in order to measure the temperature of each blade. The faster time response of nanoparticles compared to conventional phosphors would allow these techniques to be used with faster rotational speeds.

Monitoring temperature is useful during modeling of the operation of a part, to determine required tolerances, to provide feedback to a system to optimize its performance, and to monitor for changes that might indicate a need for maintenance.

### EXAMPLE 9

In much industrial manufacturing, the temperature of a process must be monitored during the process. In some cases, a non-contact optical measurement is required. If there is a large amount of background heat, determining temperature by fluorescence will be more accurate than determining temperature by the levels of infrared light present. The use of conventional phosphors to determine temperature of steel as it is galvannealed has been demonstrated in U.S. Pat. No. 6,123,455. In this case, the phosphor is sprayed onto the steel as it leaves the galvannealling furnace. Approximately 0.5 s is required for the phosphor to come to thermal equilibrium after being sprayed on. If a nanoparticle phosphor were used, the thinner coating should lead to faster thermal equilibrium and a measurement of temperature could be made sooner after the steel leaves the furnace.

In semiconductor processing, rapid thermal processing of wafers is generally conducted using IR lamps as the heating source. The background IR light limits the use of IR imaging for temperature measurements in this application. However, it would be desirable to use an imaging technique to verify that temperature is constant across the wafer, rather than using multiple thermocouples, hence nanoparticle fluorescence thermometry.

### EXAMPLE 10

Spatially resolved temperature monitoring can establish regions of an integrated circuit in which heat builds up and suggest improvements in design of the circuit or its cooling system. The high spatial resolution enabled by nanoparticle fluorescence could be particularly useful as devices become smaller, especially when combined with Micro-Electro-Mechanical Systems (MEMS) devices, microfluidic devices, or “lab-on-a-chip” devices. As more features are integrated on such devices, temperature and pressure measurements may be useful both intrinsically and to compensate for other processes or measurements that are temperature or pressure dependent.

In general, the spatial resolution of temperature or pressure sensing using nanoparticles is likely to be limited by the optics of the excitation and detection rather than the nanoparticle size. Near-Field Scanning Optical Microscopy (NSOM) has made the detection of fluorescence from single molecules or nanoparticles possible. This would be the ultimate in high spatial resolution detection.

### EXAMPLE 11

Pressure sensitive nanoparticles could be coated on an optical fiber and deployed from the ocean surface to measure the pressure in deep ocean. Nanoparticle coatings on windows can be used on submarine or on divers' goggles (in conjunction with an excitation light source) as a visual alert of the pressure.

### EXAMPLE 12

Laser cooling of a solid may occur when the average energy of the photons emitted by the solid is larger than the energy of the photons it absorbs. A crucial additional requirement is that the non-radiative decay rates of the laser-pumped states be negligible in comparison to their radiative decay rates. Organic phosphors, such as rhodamine, are used to monitoring the temperature changes during the cooling process. Our temperature sensitive nanoparticles could be used to replace the organic phosphors for better performance, such as higher spatial resolution and less photobleaching.

### EXAMPLE 13

High speed, low thermal mass, and small size are needed to characterize small scale ocean temperature features where the temperature needs to be measured at ˜10⁻⁵ s time scale at an accuracy of less than ±0.01° C. Additional sensors of interest are conductivity and depth, especially with small size and high speed capabilities. Current commercial microscale temperature sensor, such as the high-speed thermistor from SeaBird (http://www.seabird.com/pdf documents/datasheets/08brochure.pdf), has 1000 Hz data sample rate, but the sensor can only operate at 22 Hz, mostly due to the thermal mass of the sensor element. Due to the extremely small size, and fast fluorescence decay time, temperature sensitive nanoparticles can be used to make tiny thermal sensors that have very low thermal mass, for rapid temperature sensing, to be used in above applications. One configuration is to use a nanoparticle coated fiber optic tip.

### EXAMPLE 14

The recipes for making CdSe, CdS, and ZnS nanoparticles have been reported in Refs T. Rajh, O. I. Micic and A. J. Nozik, Synthesis and characterization of surface-modified colloidal CdTe quantum dots, J. Phys. Chem. 97, 11999 (1993); A. L. Rogach, L. Katsikas, A. Kornowski, D. Su, A. Eychmuller and H. Weller, Ber. Bunsenges. Synthesis and characterization of thiol-stabilized CdTe nanocrystals, Phys. Chem. 100, 1772 (1996); T. Stimer, N. T. Kirkman, L. May, C. Ellis, J. E. Nicholls, S. M. Kelly, M. O'Neill and J. H. C. Hogg, CdTe nanocrystals: Synthesis, optical characterization, and pseudopotential calculation of the band gap, J. Nanosci. Nanotech. 1, 451-455 (2001), the entire content of such reference is hereby expressly incorporated herein by reference. Here we include the recipe for making CdTe nanoparticles by a wet chemical technique. All chemicals were used as received from Aldrich, Alfa Aesar, or Sigma. CdTe nanoparticles were prepared by the rapid mixing of precursor solutions containing cadmium perchlorate hydrate and sodium hydrotelluride (NaHTe), cooled to 5° C., under vigorous stirring. The Cd²⁺ containing solution was prepared as follows: 0.73 g. of Cd(ClO₄)₂*H₂O was dissolved in 125 mL of water. 0.3 mL of thioglycolic acid (TGA) was added to the solution and its pH was adjusted to ˜11.2 by the addition of 0.1 M NaOH. The solution was then purged with nitrogen for at least 30 minutes. The solution of NaHTe was prepared in a vessel cooled with ice water to 5° C., by bubbling an excess of H₂Te through 22 mL of 0.05M NaOH for 40 minutes under nitrogen. The hydrogen telluride gas was obtained from the reaction of excessive amounts of Al₂Te₃ and 0.5M H₂SO₄ in an inert atmosphere (nitrogen). Great care was taken to keep the NaHTe solution temperature at an average of 5° C., as well as to avoid any contact of the solutions involved with oxygen (air) at all times.

After the completion of the reaction, a yellow solution of CdTe nanocrystal nuclei was obtained. This solution was then refluxed at 100° C. to promote crystal growth. The size of the particles was controlled by the reaction time. The size of the nanoparticles used in this invention is around 4 nm as observed by high-resolution transmission electron microscope (HRTEM). Most of these nanoparticles are spherical in shape, while some of them are nonspherical.

The nanoparticles were dispersed in acetone, dropped on a glass cover slip, and air dried to form a thin solid film. The glass cover slip was then placed on an in-house manufactured sample holder with a Omega temperature controller. The fluorescence spectra were measured with a fluorometer. Generally, the intensity of the fluorescence decreases as the temperature increases, with a slight blue or red band shift in some cases. The luminescence at low temperature was collected using a SPEX Flourolog II fluorimeter. The fluorimeter was equipped with a 450 W xenon arc lamp, double monochromators (SPEX 1680) for excitation and emission, and a cooled photomultiplier tube. The nanoparticle sample was mounted on the cold finger of a liquid helium flow-through cryostat using indium metal for thermal contact. The cold finger was equipped with a heater element and the temperature was controlled by a Lakeshore Model 330 temperature controller that monitored the temperature with a calibrated silicon diode attached to the indium metal at the sample position.

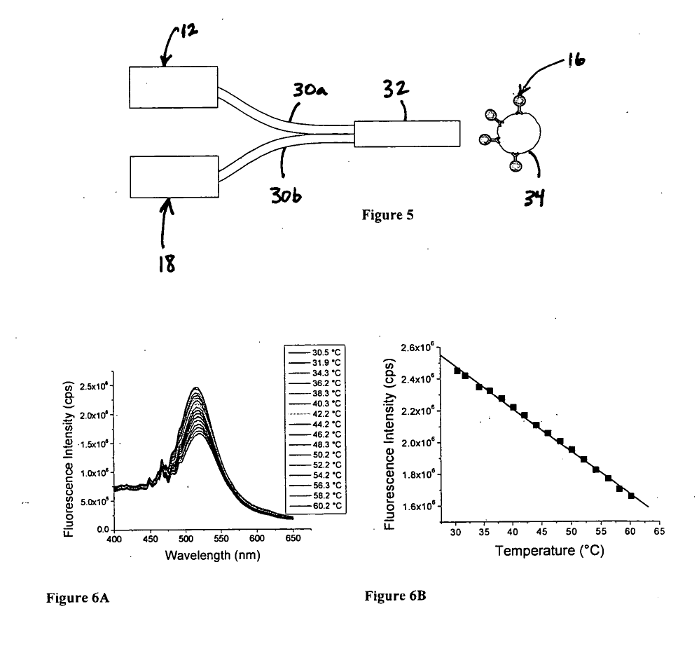

The fluorescence peak intensity is linearly and reversibly proportional to the temperature in the 30 to 60° C. range, with a large slope of 1.1% per ° C., (as shown in FIGS. 6A and 6B). CdTe nanoparticles could be suitable candidates for biomedical applications (in vivo and in vitro thermometry) due to their large and linear intensity shift over the physiological and hyperthermia temperature range. The —COOH group of the thioglycolic acid stabilized CdTe nanoparticle can be used to conjugate to the amine group of biological molecules (for example, antibodies) easily, such as by the widely used EDC/NHS reaction.

The signal to noise ratio of our fluorescence spectrometer is about 5000:1, which means it can detect a 0.02% change in fluorescence intensity. The CdTe nanoparticles have temperature dependence of 1.1% per ° C., which means we can get resolution as good as 0.02° C. in principle.

### EXAMPLE 15

The recipes for making CdS:Mn²⁺, ZnS:Mn²⁺, ZnS:Eu³⁺, MgS:Eu³⁺ nanoparticles are similar as discussed in W. Chen, R. Sammynaiken, Y. Huang, J. Appl. Phys. Luminescence Enhancement of ZnS:Mn Nanoclusters in Zeolite, 2000, 88, 5188 (2000); W. Chen, R. Sammynaiken, Y. Huang, J-O Malm, R. Wallenberg, J-O Bovin, V. Zwiller and N. A. Kotov, Crystal Field, Phonon Coupling and Emission Shift of Mn²⁺ in ZnS:Mn Nanoparticles, J. Appl. Phys. 89,1120 (2001).; W. Chen, J-O. Malm, V. Zwiller, Y. Huang, S. M. Liu, R. Wallenberg, J-O. Bovin, and L. Samuelson, Energy structure and fluorescence of Eu²⁺ in ZnS:Eu nanoparticles, Phys. Rev. B, 61, 11021 (2000), the entire content of such reference is hereby expressly incorporated herein by reference. The recipe for making uncapped ZnS:Mn nanoparticles is as follows: A four-neck flask was charged with 400 mL deionized water and was stirred under N₂ for 2.5 hrs. An aqueous solution of 1.6 g Na₂S and an aqueous solution of 5.8 g Zn(NO₃)₂.6(H₂O) and 0.26 g Mn(NO₃)₂ (Mn²⁺/Zn²⁺ molar ratio 5:95) were prepared and added to the first solution simultaneously via two different necks at the same rate. After the addition, the resulting solution was stirred constantly under N₂ at 80° C. for 24 hrs and a transparent colloid of ZnS:Mn was formed. The pH value of the final solution was 2.4. This relatively low pH value is required to prevent the precipitation of unwanted Mn species. The nanoparticles were separated from solution by centrifugation and dried in vacuum at room temperature. The particle size is around 10 nm as determined by HRTEM.

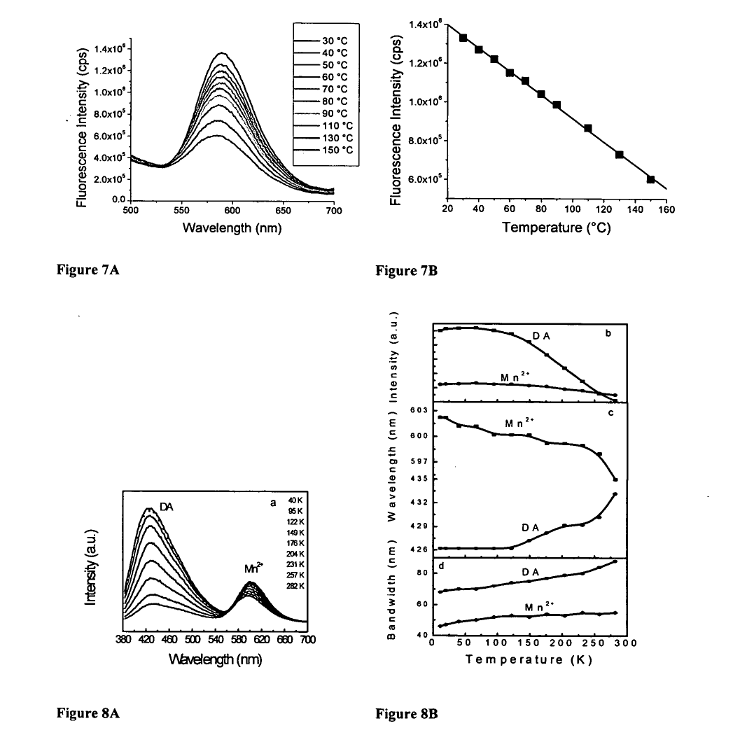

Referring to FIGS. 7A and 7B, the fluorescence peak intensity at 589 nm shows a linear and reversible response to temperature between 30 and 150° C. for ZnS:Mn²⁺ nanoparticles of 10 nm size excited at 360 nm. The change of intensity is nearly 0.5% per ° C. The peak position also shows a slight blue shift, about 0.05 nm/° C.

When excited at 300 nm, the ZnS:Mn nanoparticles show both orange emission from the Mn²⁺ and blue emission from ZnS defects. At this excitation wavelength, the ZnS host lattice is being excited; the emission from Mn²⁺ relies upon energy transfer. The temperature dependence of both emissions following excitation at 300 nm are displayed in FIG. 8A. The intensity of Mn²⁺ emission is weakly dependent on temperature (FIG. 8B), which is consistent with previous results, as discussed in A. G Joly, W. Chen, J. Roark, and J. Z. Zhang, Temperature dependence of Up-Conversion Luminescence of Mn²⁺ in ZnS:Mn Nanoparticles, Journal of Nanoscience and Nanotechnology, 2001, 1 (3): 295-301, the entire content of such reference is hereby expressly incorporated herein by reference. The blue emission intensity, however, shows a much more pronounced decrease with decreasing temperature. FIG. 8B also shows the changes in emission energy as a function of temperature. As the temperature decreases, the Mn²⁺ emission shifts to longer wavelengths. On the contrary, the blue emission shifts to shorter wavelengths with decreasing temperature. FIG. 8B displays the changes in the full-width at half-maximum (FWHM) bandwidth of both emissions as a function of temperature. The bandwidths of both emissions show weak temperature dependence with slight decreases as the temperature is lowered.

### EXAMPLE 16

For making BaFBr:Eu²⁺ nanoparticles in MCM-41, bulk BaFBr:Eu²⁺ powder was made by solid state diffusion at 800° C. for 2 hours. Then, BaFBr:Eu²⁺ powder and MCM-41 powder (ratio of BaFBr:Eu²⁺/MCM-41 is 5:95) were mixed together and heated at 600° C. under N₂ for 2 hours.

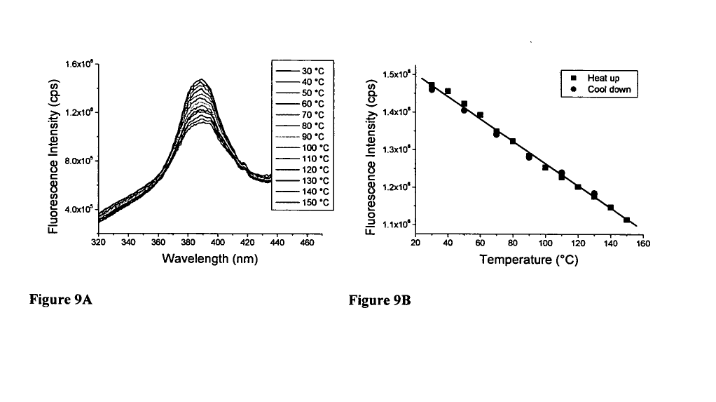

Referring to FIGS. 9A and 9B, the peak intensity of fluorescence responds linearly and reversibly to temperature between 30 to 150° C. at rate of 0.2% per ° C. for BaFBr:Eu²⁺ nanoparticles in MCM-41. This nanoparticle also shows exceptional stability over time. The signal to noise ratio of our fluorescence spectrometer is about 5000:1, which means it can detect a 0.02% change in fluorescence intensity. For the relatively small changes of BaFBr:Eu²⁺ nanoparticles of 0.2% per ° C., resolution of 0.1° C. is still possible.

### EXAMPLE 17

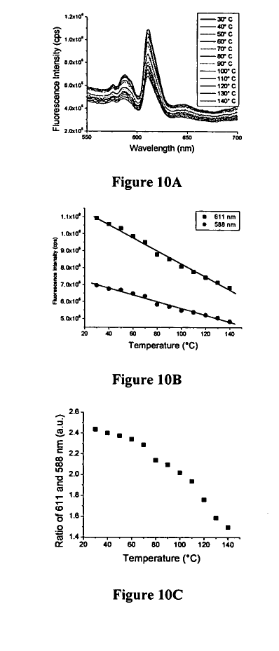

Referring to FIGS. 10A-10C, Eu³⁺ nanoparticles were prepared in zeolite. The intensities of the two major emission peaks are linearly proportional to temperature between 30 and 140° C. The ratio of the two peaks also shows dramatic shifts with temperature. The measurement of peak ratio could be much easier and more reliable than a single peak intensity measurement in practical application. This is because variations of the optical path, such as bend of an optical fiber or skin penetration, could change the detected fluorescence intensity easily, but the ratio of the two peak intensities is much less dependent on these factors.

### EXAMPLE 18

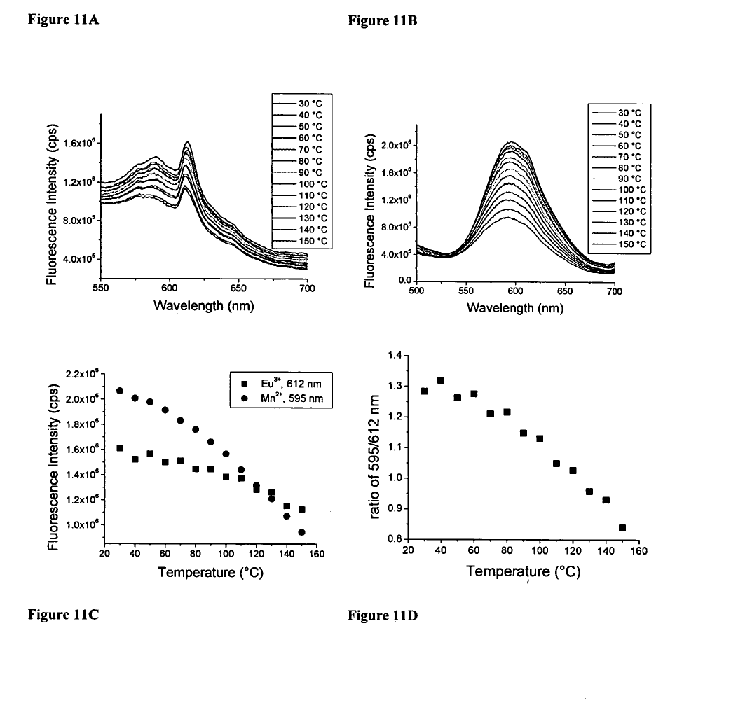

Referring to FIGS. 11A-11D, to find more candidates for the two-peak approach of fluorescence thermometry, we synthesized and tested doubly-doped nanoparticles of ZnS:Mn²⁺,Eu³⁺. The shape of the fluorescence spectra of this double-doped nanoparticle depends on the excitation wavelength. When excited at 394 nm, the emission spectrum is mainly contributed by Eu³⁺, with the major peak position at 612 nm. When excited at 360 nm, the emission spectrum is mainly due to Mn²⁺, with a peak position at 595 nm. The f-f transition induced emission of Eu³⁺ is less temperature dependent than the d-d transition induced emission of Mn²⁺. The ratio of the two peaks has a fairly linear response to temperature changes over the range of 30 to 150° C.

### EXAMPLE 19

Anionic poly (phenylene ethynylene) (aPPE) possessing pendant sulfonate groups were prepared by a co-polymerization described in W. Chen, A. G. Joly, J.-O. Malm, J.-O. Bovin, and S. Wang, Full-Color Emission and Temperature Dependence of the Luminescence in Poly-P-Phenylene Ethynylene-ZnS:Mn²⁺ Composite Particles, Journal of Physical Chemistry B, in press, the entire content of such reference is hereby expressly incorporated herein by reference. A polymer particle solution was made by dissolving 0.05 g aPPE particles in 5 ml DMF and 10 ml water. The particle size of the polymer prepared in this way is about 500 nm. A semiconductor nanoparticle solution was made by dissolving 0.5 g of the PVA-stabilized ZnS:Mn²⁺ nanoparticle powder into 10 ml water and 10 ml ethanol. The two solutions (1:1) were mixed, stirred and heated at 60° C. under nitrogen protection for 1 hour. A thin film was made by dropping the solution on a glass substrate and dried at room temperature.

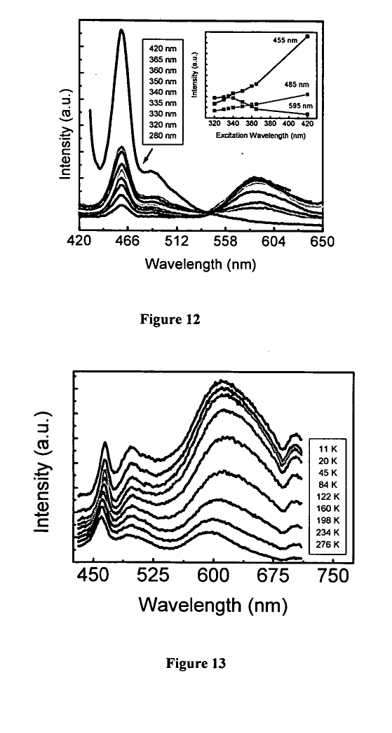

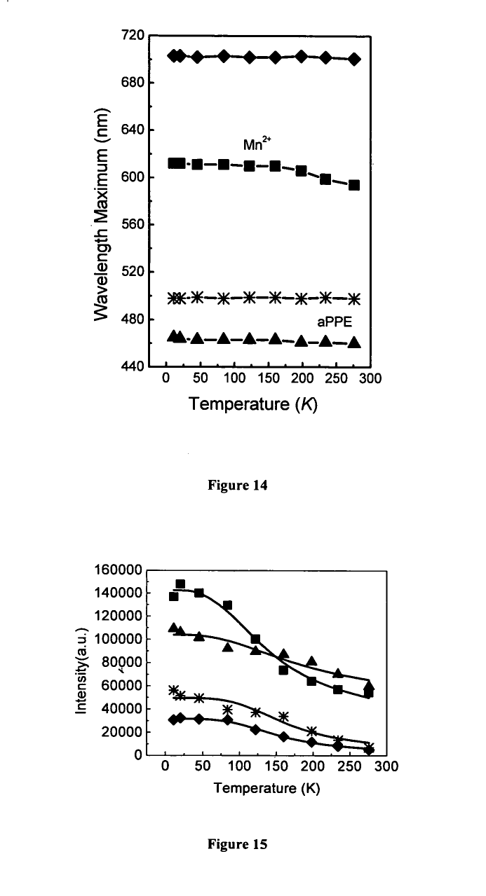

As displayed in FIG. 12, the overall emission color of the nanocomposite changes for different excitation wavelengths because the relative emission intensities of Mn²⁺ and aPPE particles change. Referring to FIGS. 13-15 the emission spectra, emission wavelength maxima, and the emission intensity at low temperatures are shown. All of the emission bands shift to the red with decreasing temperature although the shift in the peak position is not very dramatic. All the emissions decrease in intensity with increasing temperature with the decrease of the Mn²⁺ emission at 596 nm much larger than the decrease of the emissions of aPPE particles.

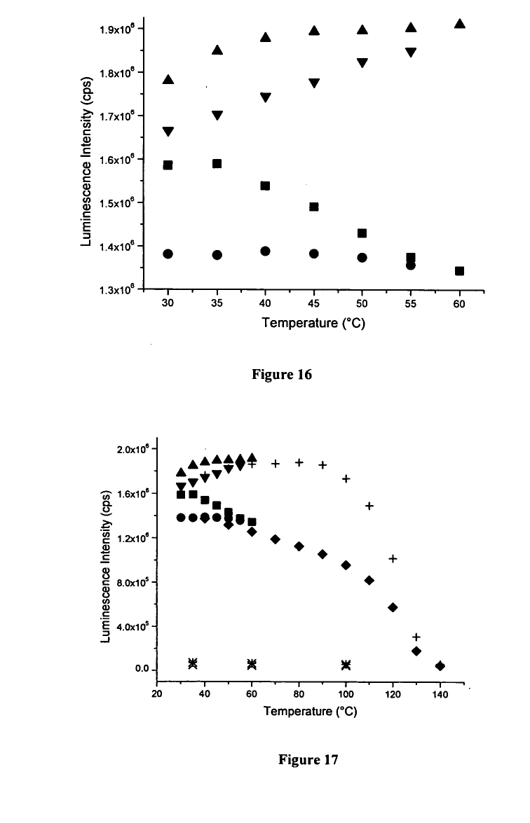

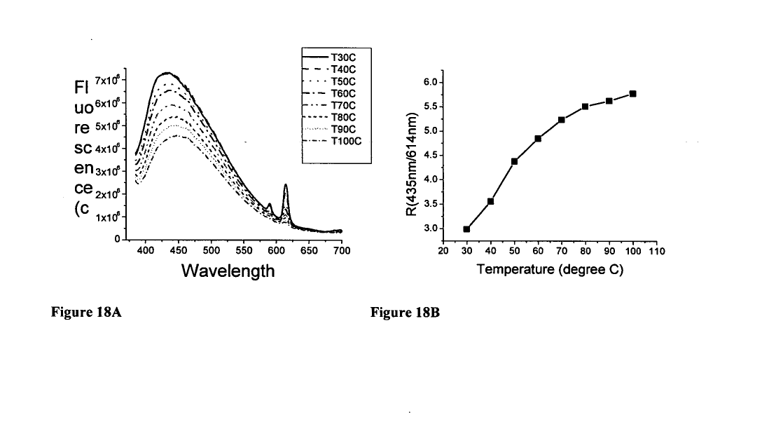

FIGS. 16 and 17 show the luminescence intensity temperature dependence of the emission at 460 nm and 596 nm at temperatures above room temperature for the nanocomposite material. FIG. 16 shows the dependence from room temperature to 60° C. It is surprising to observe that the emission of Mn²⁺ at 596 nm (FIG. 16, ▴) increases while the emission of aPPE particles at 460 nm (FIG. 16, ▪) decreases with increasing temperature. Upon subsequent cooling, the emission intensity at 596 nm (FIG. 16, ▾) decreases although the intensity does not recover to its original value. Similarly, the intensity of the aPPE emission at 460 nm (FIG. 16, ●) does not recover to its initial value upon cooling. FIG. 17 shows the intensity dependence up to 140° C. following one cycle of heating and cooling described above. The blue emission of APPE particles decreases gradually with increasing temperature (FIG. 17, ♦). However, the luminescence of Mn²⁺ at 596 nm increases with increasing temperature up to 90° C. (FIG. 17, +). When the temperature is higher than 90° C, the luminescence is quenched rapidly. At 140° C. both the emissions of aPPE particles and the Mn²⁺ emission are quenched completely. In either species, the luminescence does not recover following subsequent cooling (FIG. 17, X, *). It seems likely that these luminescence changes are associated with permanent chemical changes.

Thus, although this nanocomposite is not well suited for elevated temperature applications, the change in the relative intensities of the polymer particles and the semiconductor particles with temperature makes this nanocomposite a potential temperature indicator below room temperature.

### EXAMPLE 20

Referring now to FIGS. 18A and 18B, In₂S₃:Eu³⁺ nanoparticles is another example that allowed measuring ratios between 2 emission peaks that reflect the temperature change. This time, a single excitation wavelength 370 nm was used, and both peak at 435 nm (In³⁺) and 614 nm (Eu³⁺) are decreasing when temperature increased, but at a different rate. The ratio of the two peaks is a function of temperature.

### EXAMPLE 21

Different sized ZnS:Mn particles were made. The sizes are estimated from high-resolution transmission electron microscopy (HRTEM) and x-ray diffraction (XRD), and are approximately 1, 3, 3.5, 4.5 and 10 nm, respectively. The 10 nm-sized particles were naked without any capping, while the 3 and 4.5 nm-sized particles were capped with methacrylic acid and the 3.5 nm-sized particles were capped with methacrylic acid and citric acid. On the other hand, the nanoparticles of 1 nm were formed in cavities of ultrastable zeolite-Y (USY) by solid state diffusion at high temperature. A commercial bulk ZnS:Mn sample was also measured for comparison.

The photoluminescence (PL) measurements under hydrostatic pressure were performed in a gasketed diamond-anvil cell (DAC) at room temperature. Some powder samples, together with a piece of ruby chip, were placed in a stainless-steel gasket with a hole 300 μm in diameter. A 4:1 methanol-ethanol mixture was used as the pressure-transmitting medium. The pressure was determined by using the standard ruby-fluorescence technique and could be varied from 0 to 6 GPa. For the measurement of emission spectra, the 488 nm line of an Ar⁺ ion laser was used as an excitation source. The emitted light was dispersed by a JY-HRD1 double grating monochromator and detected by a cooled GaAs photomultiplier tube operating in the photon-counting mode.

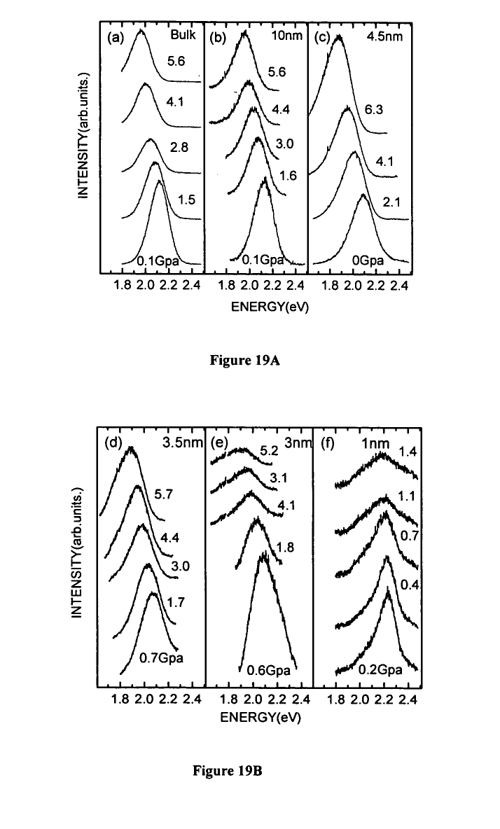

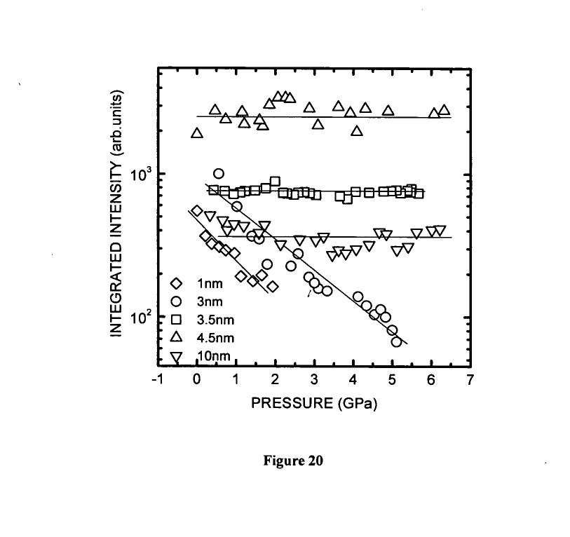

As shown in FIGS. 19A and 19B, the luminescence spectra at different pressures are displayed. The Mn²⁺ emission shifts to lower energy levels with increasing pressure. For bulk and the particles 10 nm, 4.5 μm, and 3.5 nm in size, the emission intensity is weakly dependent on pressure, while for the 3 nm and 1 nm nanoparticles the emission intensity of Mn²⁺ decreases prominently with increasing pressure. Referring to FIG. 20, the pressure dependence of the integrated intensity of the Mn²⁺ emissions is shown. The decrease in intensity is so strongly dependent on increasing pressure for the 1 nm-sized particles that no luminescence is detectable when the pressure is higher than 1.4 GPa. It is noted that the intensities of Mn²⁺ emissions in the 3 nm- and 1 nm-sized particles are weaker than those of other samples under 488 nm excitation at atmospheric pressure.

For smaller particles, the variation of the surface-to-volume ratio with pressure is larger. This may accelerate the energy transfer from Mn²⁺ ions to the surface-related defects in smaller particles, quenching the luminescence more strongly.

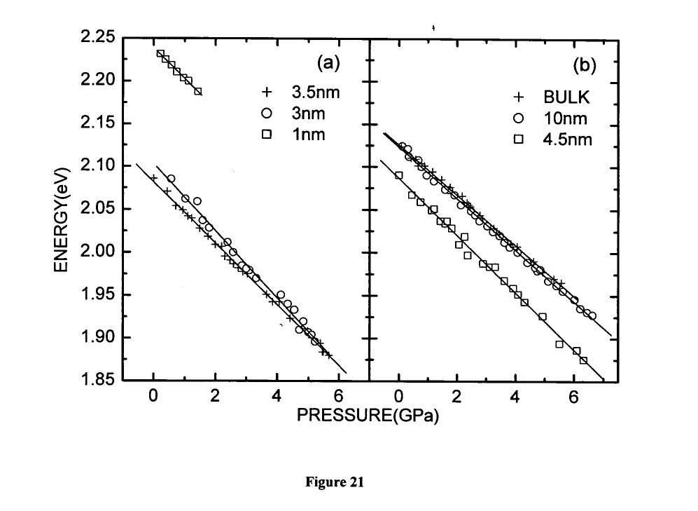

Referring to FIG. 21, the pressure dependence of the PL peak energy for orange emission (from the Mn²⁺) is shown. The solid lines represent the result of the least-squares fit to the experimental data using the linear relationship
E(P)=E₀+αP (5)
where α is the pressure coefficient and E₀ represents the emission energy at P=0 GPa. The obtained pressure coefficients are −36, −39, −35.7, −33.3, −30.1, and −29.4 meV/GPa for the 1 nm, 3 nm, 3.5 nm, 4.5 nm, 10 nm, and bulk samples, respectively. The absolute values of the pressure coefficients of the nanoparticles are larger than that of the bulk sample. Moreover, the absolute pressure coefficient increases with decreasing particle size with the 1 nm-sized particles as an exception, which is a little smaller than that of the 3 nm-sized sample. As pointed out, the special behavior of the 1 nm-sized particles is probably related to their special environments as they are encapsulated in. It was also observed that the temperature dependence of its emission energy is similar to that of bulk ZnS:Mn²⁺, even though most Mn²⁺ ions are at the near-surface sites in the particles formed in zeolite-Y. This is attributed to the fact that surface passivation of the nanoparticles encapsulated in zeolites is actually via chemical bonding between the anions (Zn²⁺) at the nanoparticle surfaces and the zeolite-framework oxygen ions (O²⁻). In this case, surrounding Mn²⁺ in ZnS:Mn²⁺ in zeolite is similar to Mn²⁺ in bulk ZnS:Mn²⁺. This is likely the reason for the sample having luminescence temperature behaviors similar to bulk. Similarly, we believe this is the reason why the 1 nm-sized particles have a lower pressure coefficient value (absolute) than that of the 3 nm-sized particles.

The pressure dependence of Mn²⁺ emission in ZnS:Mn²⁺ can be calculated by using crystal field theory. There is a change in crystal field strength due both to the volume compressibility of the ZnS structure and to the variation of inner shell electron states of Mn²⁺ with pressure. The calculated pressure coefficients for nanosized samples are also in agreement with the experimental data qualitatively.

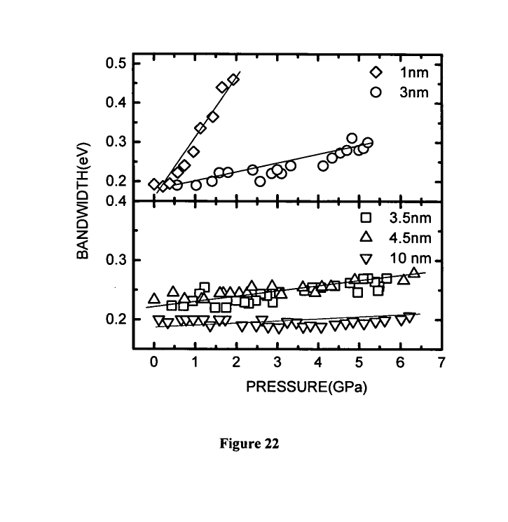

In addition to the emission energy and intensity, the pressure dependence of the emission bandwidth of Mn²⁺ in ZnS:Mn²⁺ nanoparticles is also size-dependent. As shown in FIG. 22, the pressure dependence of the bandwidth of different sized particles. It is interesting to see that the bandwidth increase is faster with increasing pressure for smaller particles. The emission bandwidth increases slowly with increase of pressure for 10, 4.5 and 3.5 nm samples whereas, the bandwidth increases significantly with increasing pressure for 3 and 1 nm particles. the emission bandwidth is mainly determined by electron-phonon coupling and the LO-phonon frequency. The increase of phonon frequency is perhaps one of the reason for the faster increase of the bandwidth with increasing pressure for smaller particles.

The emission shifts to lower energies with increasing pressure and the shift rate (the absolute value of the pressure coefficient) is larger in the ZnS:Mn²⁺ nanoparticles than in bulk. The pressure coefficient increases with the decrease of the particle size with the 1 nm-sized particles as an exception. The pressure coefficients calculated based on the crystal field theory are in agreement with the experimental results. It is also observed that for particles with average sizes of 3.5, 4.5, 10 nm and bulk ZnS:Mn²⁺, the luminescence intensity of Mn²⁺ is weakly dependent on pressure, while for particles 1 and 3 nm in size, the luminescence intensity of Mn²⁺ is quenched dramatically at increasing pressure. The bandwidth increase is faster with increasing pressure for smaller particles. This is attributed to the fact that more Mn²⁺ ions are at the near-surface sites and because of the increase of the phonon frequency for smaller nanoparticles.

The luminescence of CdS, CdSe, and CdSₓSeₓ₋₁ nanoparticles has also been found to be pressure dependent (see J. Schroeder and P. D. Persans, Spectroscopy of II-VI nanocrystals at high pressure and high temperature, Journal of Luminescence, 1996, 70: 69-84) At high pressures, there is also a structural phase transition. The luminescence change along with the structural change will make it complicated for a pressure sensor. However, the critical pressure for phase transition is very high. At pressures below this critical pressure point, pressure sensors is possible to fabricate based on its linear- or close-linear relationship between the intensity or energy of the luminescence with the pressure.

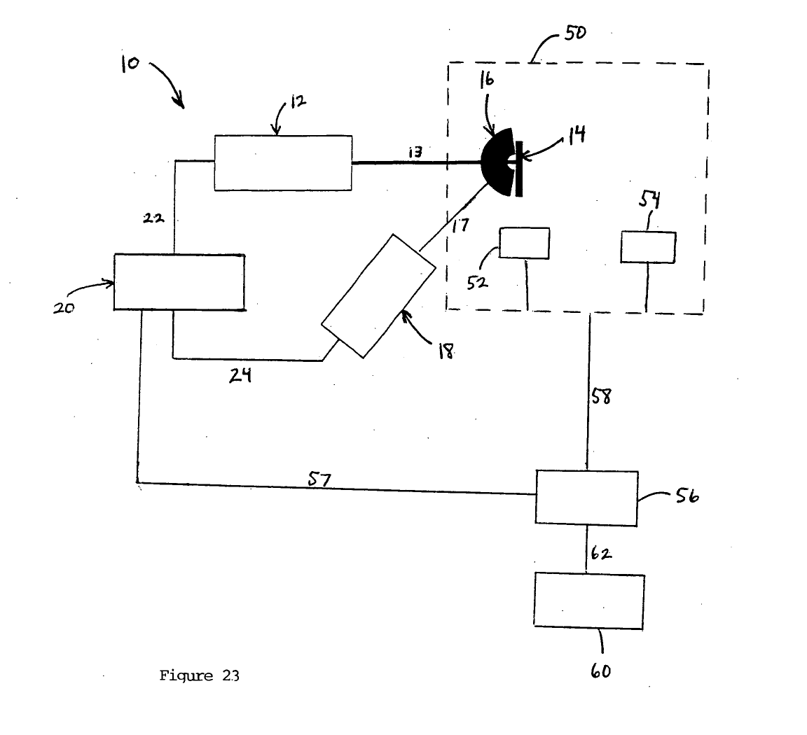

Referring to FIG. 23, the sample 14, coated with the sensory material 16, is calibrated for temperature and/or pressure after the sensor 10 has been constructed, but before the light source 12 is utilized to shine light on the sample 14. The sample 14 is disposed into an environmental chamber 50 which can be a conventional environmental chamber. The environmental chamber 50 is provided with a temperature sensor 52 and/or a pressure sensor 54. The temperature sensor 52 and/or pressure sensor 54 are connected to communicate with an interface device 56 via a signal path 58.

The processor 20 is to communicate with the interface device 56 via a signal path 57 so that signals from the light source 12 and the detector 18 are output by processor 20 to the interface device 56.

The interface device 56 receives the signals transmitted by the temperature sensor 52 and/or the pressure sensor 54, and converts such signals into signals capable of being received by a computer 60 via a signal path 62. The computer 60 can be a standard personal computer, and the signal path 62 can be an RS232 serial bus. Thus, it can be seen that the signal from the detector 18 and the temperature and/or pressures sensors, 52 and 54, are communicated to the computer 60 via the interface device 56 so that the computer 60 receives signals indicative the fluorescence from the sensory material 16 and the temperature and/or pressure in real time.

While the sensor 10 is operating during temperature calibration, as discussed previously, the environmental temperature surrounding the sensor 10 is swept through a range from about 32° F. to about 140° F. The light source 12 is used to excite the sensory material 16 and the fluorescence 17 is detected by the detector 18. The processor 20 receives the signal indicative of the fluorescence from the sensory material 16, the temperature signal. Note that pressure should be held constant during temperature calibration. These two signals, which may both be analog signals, are converted by the processor 20 into digital signals, if necessary. The two signals are then transmitted to the computer 60 via the interface device 56 and signal paths 57 and 58, as previously discussed.

The computer 60 computes an array of the known temperature calibration values and the signal indicative of the fluorescence from the sensory material 16. It should be noted that during calibration, the sample 14 is maintained in a fixed, known location between the laser 12 and the detector 18.

This calibration is stored on the computer 60 in the form of a table matching the fluorescence from the sensory material 16 (intensity, wavelength, bandwidth, lifetime, or excitation spectra) and the corresponding temperature.

After the temperature has been swept in the environmental chamber 50, the processor 20 is programmed with the table produced by the computer 60 so that the processor 20 has access to such table.

The table of information programmed (or stored) in the processor 20 is then utilized by the processor 20 to generate the sensor output signal of temperature. A similar process would be carried out with a constant temperature and changing pressure in the environmental chamber to calibrate a pressure sensor.

Most often, these sensors will be used in applications in which either temperature or pressure is changing but not both. If both temperature and pressure are changing, then options include using an external sensor to compensate for one of the variables or using multiple nanoparticles or multiple emittors which have a different response to temperature and/or pressure to compensate.

All of the included references in the application are specifically incorporated herein by reference in their entirety as though set forth herein particular.

Changes may be made in the embodiments of the invention described herein, or in the parts or the elements of the embodiments described herein, or in the steps or sequences of steps of the methods described herein, without departing from the spirit and/or scope of the invention as defined in the following claims.

What is claimed:

1. A nanoparticle fluorescence (or upconversion) sensor, comprising:
an electromagnetic source emitting an excitation;
a sample positioned within the excitation emitted by the electromagnetic source; and
sensory material associated with at least a portion of the sample and receiving at least a portion of the excitation emitted by the electromagnetic source, the sensory material including a plurality of luminescent nanoparticles luminescing upon receipt of the excitation, with the luminance emitted by the luminescent nanoparticles changing based on at least one of temperature and pressure;
a detector receiving at least a portion of the luminance emitted by the luminescent nanoparticles and outputting a signal indicative of such luminance; and
means for correlating said signal into a measurement of the temperature or pressure adjacent to the sensory material.

2. The nanoparticle fluorescence or upconversion sensor of claim 1, wherein the means for correlating outputs a temperature signal whereby the nanoparticle fluorescence or upconversion sensor functions as a thermometer.

3. The nanoparticle fluorescence or upconversion sensor of claim 1, wherein the means for correlating outputs a pressure signal whereby the nanoparticle fluorescence or upconversion sensor functions as a pressure meter.

4. The nanoparticle fluorescence or upconversion sensor of claim 1, wherein the means for correlating is based on at least one of the following luminance properties: luminescence intensity, emission wavelength (energy), peak width, decay lifetime and/or wavelength and peak width of excitation spectra.

5. The nanoparticle fluorescence or upconversion sensor of claim 1, wherein the luminescent nanoparticles are selected from the group comprising semiconductor nanoparticles, insulator nanoparticles, doped nanoparticles, and organic and polymer nanoparticles.

5a. The nanoparticle fluorescence or upconversion sensor of claim 5, wherein the semiconductor nanoparticles are selected from a group consisting of CdTe, CdSe, ZnO, CdS, ZnS, In₂S₃, InAs, InP, PbS, PbSe, PbI₂, and HgI₂.

5b. The nanoparticle fluorescence or upconversion sensor of claim 5, wherein the Mn²⁺-doped semiconductor nanoparticles are selected from a group consisting of CdS:Mn²⁺, ZnS:Mn²⁺, ZnS:Mn⁺, and Eu³⁺.

5c. The nanoparticle fluorescence or upconversion sensor of claim 5, wherein the insulator nanoparticles are selected from a group consisting of Y₂O₃, YF₃, LaF₃, Zn₂SiO₄, BaF₂, BaFBr, and Ca(PO₄)₂.

5d. The nanoparticle fluorescence or upconversion sensor of claim 5, wherein the europium-doped nanoparticles are selected from a group consisting of Y₂O₃:Eu³⁺, ZnS:Eu³⁺, Zeolite-Eu³⁺, MgS:Eu³⁺, BaFBr:Eu³⁺, BaFBr:Eu²⁺, and In₂S₃:Eu³⁺.

5e. The nanoparticle fluorescence or upconversion sensor of claim 5, wherein the dopants are selected from a group consisting of transition ions, such as Mn²⁺, Ag⁺, Cu²⁺, Tl⁺, etc., and lanthanide ions, such as Tb³⁺, Ce³⁺, Yb³⁺, and Nd³⁺.

5f. The nanoparticle fluorescence or upconversion sensor of claim 5, wherein the emitters in the nanoparticles are defects, donor-acceptor pairs, vacancies or interstitial ions.

5g. The nanoparticle fluorescence or upconversion sensor of claim 5, wherein the luminescent nanoparticles are further selected from the group comprising inductive, IR absorptive and magnetic nanoparticles to provide the ability to simultaneously heat the sample and measure the temperature.

6. The nanoparticle fluorescence or upconversion sensor of claim 1, wherein the luminescent nanoparticles emit in two or more emission bands for which the intensity ratio of the two bands is temperature sensitive, and wherein the means for correlating outputs a temperature signal whereby the nanoparticle fluorescence or upconversion sensor functions as a thermometer.

7. The nanoparticle fluorescence or upconversion sensor of claim 1, wherein the luminescent nanoparticles emit in two or more emission bands for which the intensity ratio of the two bands is pressure sensitive, and wherein the means for correlating outputs a pressure signal whereby the nanoparticle fluorescence or upconversion sensor functions as a pressure meter.

8. The nanoparticle fluorescence or upconversion sensor of claim 1, wherein the sample and sensory material are remote from the electromagnetic source, detector, and means for correlating.

9. The nanoparticle fluorescence or upconversion sensor of claim 1, wherein the sample is a moving target.

9a. The nanoparticle fluorescence or upconversion sensor of claim 8, wherein the moving target is a turbine engine blade

9b. The nanoparticle fluorescence or upconversion sensor of claim 8, wherein the moving target is a cutting tool.

9c. The nanoparticle fluorescence or upconversion sensor of claim 8, wherein the moving target is fan blade of an electric fan.

9d. The nanoparticle fluorescence or upconversion sensor of claim 8, wherein the moving target is a portion of a rocket.

9e. The nanoparticle fluorescence or upconversion sensor of claim 8, wherein the moving target is a centrifuge.

9f. The nanoparticle fluorescence or upconversion sensor of claim 8, wherein the moving target is a rotary pump.

10. The nanoparticle fluorescence or upconversion sensor of claim 1, wherein the sample is an integrated circuit.

11. The nanoparticle fluorescence or upconversion sensor of claim 1, wherein the light detector is chosen to produce a two-dimensional image.

12. The nanoparticle fluorescence or upconversion sensor of claim 1 is used for a in vivo or in vitro temperature sensing.

13. The nanoparticle fluorescence or upconversion sensor of claim 1, wherein the sensory material is conjugated with a proper carrier so as to travel into a cell or body.

14. The nanoparticle fluorescence or upconversion sensor of claim 1, wherein the sensory nanoparticles are incorporated in an optical fiber which is positioned near or in contact with the sample.

15. The nanoparticle fluorescence or upconversion sensor of claim 1, wherein the sensory nanoparticles are coated on an optical fiber which is positioned near or in contact with the sample.

16. The nanoparticle fluorescence or upconversion sensor of claim 1, wherein the sensory material consists of two or more types of nanoparticles which have different luminescence properties and are capable of energy transfer from one nanoparticle type to the other type with the rate of energy transfer dependent on temperature or pressure.

17. The nanoparticle fluorescence or upconversion sensor of claim 16, wherein the two types of nanoparticles have the same composition but different sizes.

18. The nanoparticle fluorescence or upconversion sensor of claim 16, wherein the two types of nanoparticles have different composition.

19. The nanoparticle fluorescence or upconversion sensor of claim 16, wherein the temperature or pressure dependence of the rate of energy transfer is due to the temperature or pressure dependence of the distance between the two types of nanoparticles.

20. The nanoparticle fluorescence or upconversion sensor of claim 1, wherein the sensory material consists of nanoparticles which have two or more emitters which have different luminescence properties and are capable of energy transfer from one emitter to another emittor with the rate of energy transfer dependent on temperature or pressure.
